(19) United States
(12) Patent Application Publication
(10) Pub. No.: US 2008/0021749 A1
(43) Pub. Date: Jan. 24, 2008

(54) Boiler energy management system

(76) Inventor: David Alan Hope, Flowery Branch, GA (US)

Correspondence Address: THOMAS, KAYDEN, HORSTEMEYER & RISLEY, LLP, 600 GALLERIA PARKWAY, STE 1500, ATLANTA, GA, 30339, US

(21) Appl. No.: 11/490,812

(22) Filed: Jul. 21, 2006

(51) Int. Cl. G06F 9/44; G06F 17/50

(52) U.S. Cl. 705/7

(57) ABSTRACT

Embodiments of the present disclosure provide systems and methods for managing boilers. An exemplary method comprises retrieving schedules of pricing from energy source providers; determining an operational schedule for operating different types of boilers to maximize cost saving based on the retrieved schedules of pricing, each boiler using a type of energy source during operation; transmitting the operational schedule to the different types of boilers; and operating the different types of boilers according to the operational schedule.

### TECHNICAL FIELD

The present disclosure is generally related to boilers, and more particularly, is related to a system and method for managing and switching operation of boilers to maximize cost savings.

### BACKGROUND

In commercial and industrial applications, large boilers are used in which water or other fluid is heated under pressure. The boiler uses fuels such as wood, oil, or natural gas to heat the water. Electric and electrode boilers use resistance or immersion type heating elements. These large boilers consume large amounts of energy, which is very expensive. Hence, companies are looking for ways to cut down the cost of operating the boilers.

Thus, a heretofore unaddressed need exists in the industry to address the aforementioned deficiencies.

### SUMMARY OF THE DISCLOSURE

Embodiments of the present disclosure provide systems and methods for managing boilers. An exemplary method comprises retrieving schedules of pricing from energy source providers; determining an operational schedule for operating different types of boilers to maximize cost saving based on the retrieved schedules of pricing, each boiler using a type of energy source during operation; transmitting the operational schedule to the different types of boilers; and operating the different types of boilers according to the operational schedule.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings; like reference numerals designate corresponding parts throughout the several views.

FIG. 1 is a schematic view of an embodiment of a system in which boilers can be managed to maximize cost savings.

FIG. 2 is a schematic view of an embodiment of a system, such as shown in FIG. 1, in which boilers can be managed to maximize cost savings.

FIG. 3 is a schematic view of another embodiment of a system in which different types of boilers can be operated to maximize cost saving.

FIG. 4 is a block diagram of an embodiment of an energy management system and boilers, such as shown in FIG. 1.

FIG. 5 is a flow diagram that illustrates a high-level operation of a system, such as shown in FIGS. 1, 2, 3, and 4.

FIG. 6 is a flow diagram that illustrates operation of an embodiment of an energy management system, such as shown in FIG. 1.

FIG. 7 is a flow diagram that illustrates operation of an embodiment of a boiler control box, such as shown in FIG. 4.

FIG. 8 is an exemplary operational schedule, such as described in relation to FIG. 1.

FIG. 9 is an exemplary cost savings report, such as described in relation to FIG. 7.

### DETAILED DESCRIPTION

Disclosed herein are systems and methods with which boilers can be managed to maximize cost saving. In particular, a company with different types of boilers can determine which one of the different types of boilers to use depending on cost rates of energy sources at the time of operation, e.g., natural gas, oil or electric. Exemplary systems are first described with reference to the figures. Although these systems are described in detail, they are provided for purposes of illustration only and various modifications are feasible. After exemplary systems have been described, examples of operations of the systems are provided to explain the manner in which the boilers can be managed to maximize cost saving.

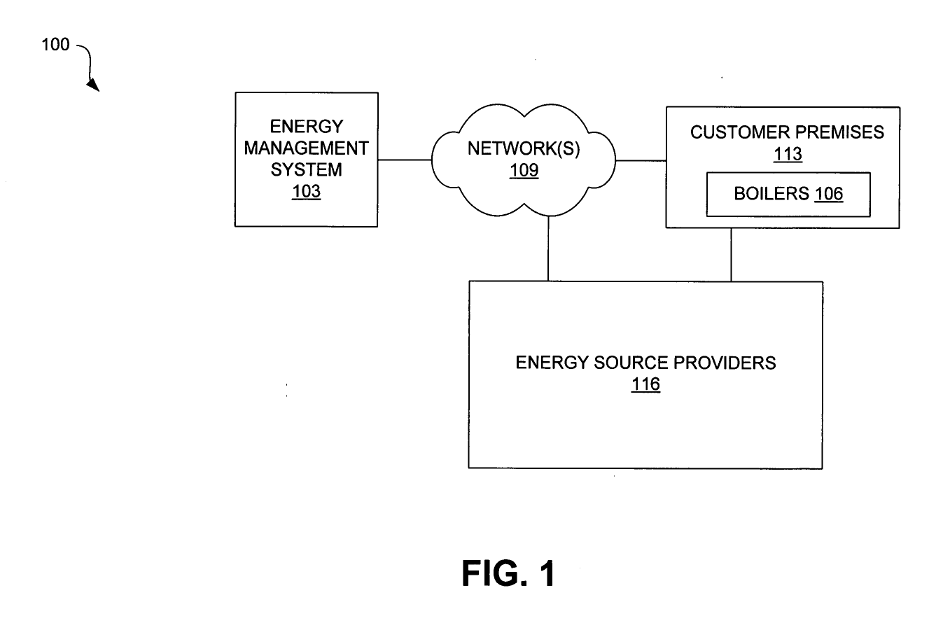

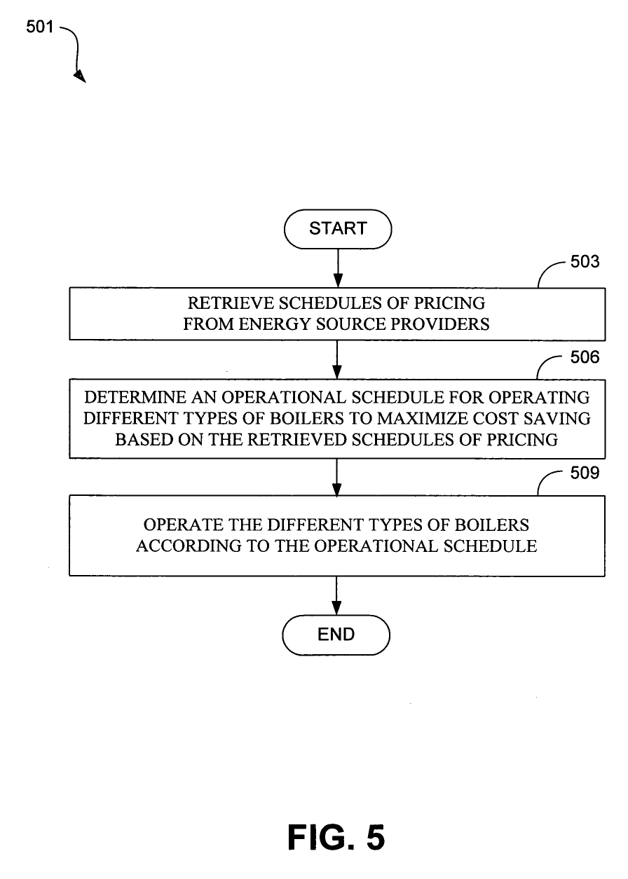

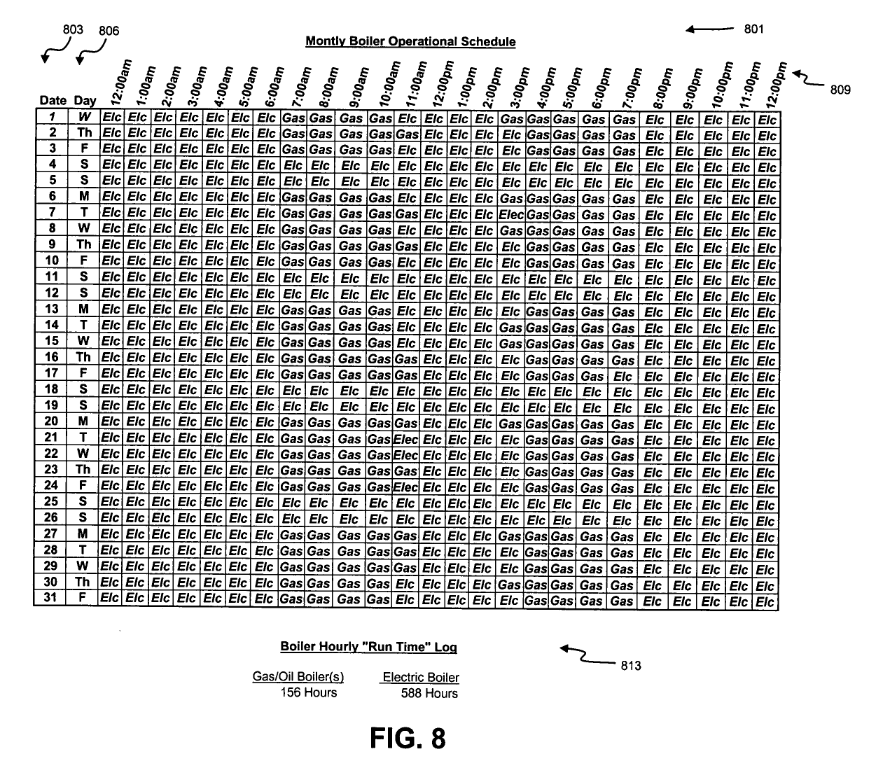

Referring now in more detail to the figures, FIG. 1 is a schematic view of an embodiment of a system in which boilers can be managed to maximize cost savings. As indicated in this figure, the system 100 can comprise an energy management system (EMS) 103 that communicates with company premises 113 and energy source providers 116 by way of network 109. The network 109 can include, but is not limited to, public switched telephone network (PSTN), Internet, wide area network (WAN), local area network (LAN), data network, cellular network and radio frequency (RF) network, for example. The company premises 113 has different types of boilers 106, with each boiler generally using one type of energy source. In general, the energy management system 103 retrieves schedules of pricing of energy sources from the energy source providers 116. The energy management system 103 determines an operational schedule based on the schedules of pricing. The operational schedule can be generated on a periodic basis, such as, hourly, daily, and weekly. An exemplary operational schedule is shown and described in relation to FIG. 8. The boilers 106 operate according to the operational schedule to maximize cost savings. Operation of the system 100 is described in relation to FIGS. 5-7.

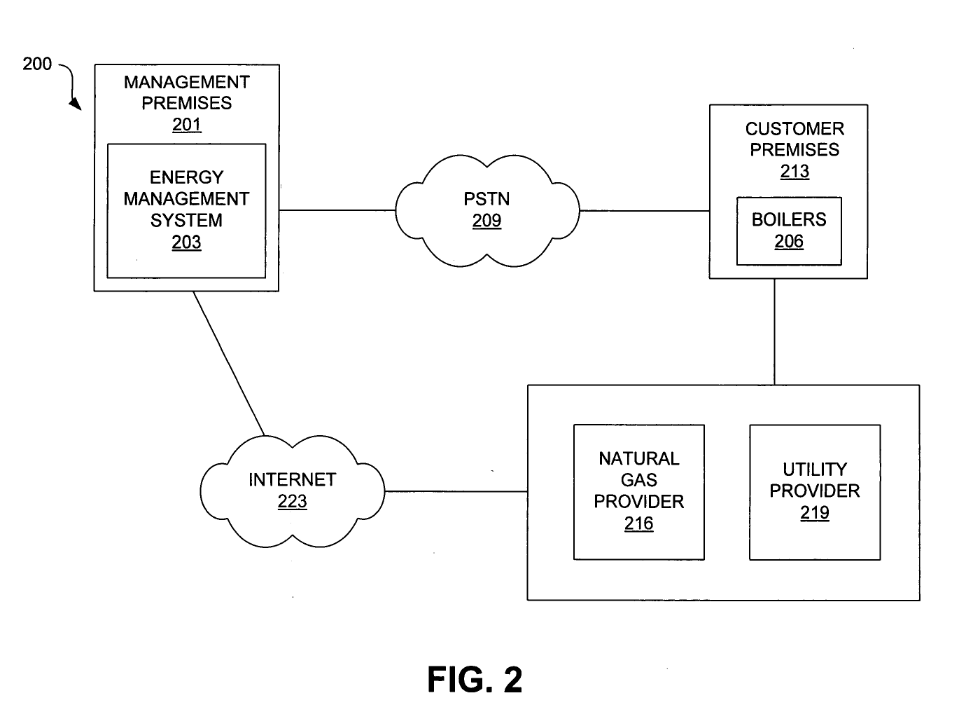

FIG. 2 is a schematic view of an embodiment of a system, such as shown in FIG. 1, in which boilers can be managed to maximize cost savings. The system 200 includes a energy management system (EMS) 203 located in a management premises 201 that communicates with different types of boilers 206 via a public switch telephone network (PSTN) 209, and communicates with both natural gas provider 216 and utility provider 219 via Internet 223. Additionally or alternatively, energy management system 203 can communicate with both the different types of boilers 206 and the energy source providers 216, 219 using only the Internet or only the PSTN. The energy management system 203 downloads a schedule of pricing from the providers 216, 219 to obtain cost rates of natural gas and electricity, respectively. The energy management system 203 determines and generates an operational schedule based on the schedules of pricing obtained from the providers 216, 219. The energy management system 203 transmits via the PSTN 209 the operational schedule to company premises 213. The operational schedule is then used to determine which type of boilers to operate in order to maximize cost savings. For example, the company 213 has an electric boiler and a gas/oil boiler. The energy management system 203 sends the operational schedule to the boilers and determines which boilers to operate. The electric and/or the gas/oil boilers are turned on or operated based on the operational schedule. Operation of the system 200 is described in relation to FIGS. 5-7.

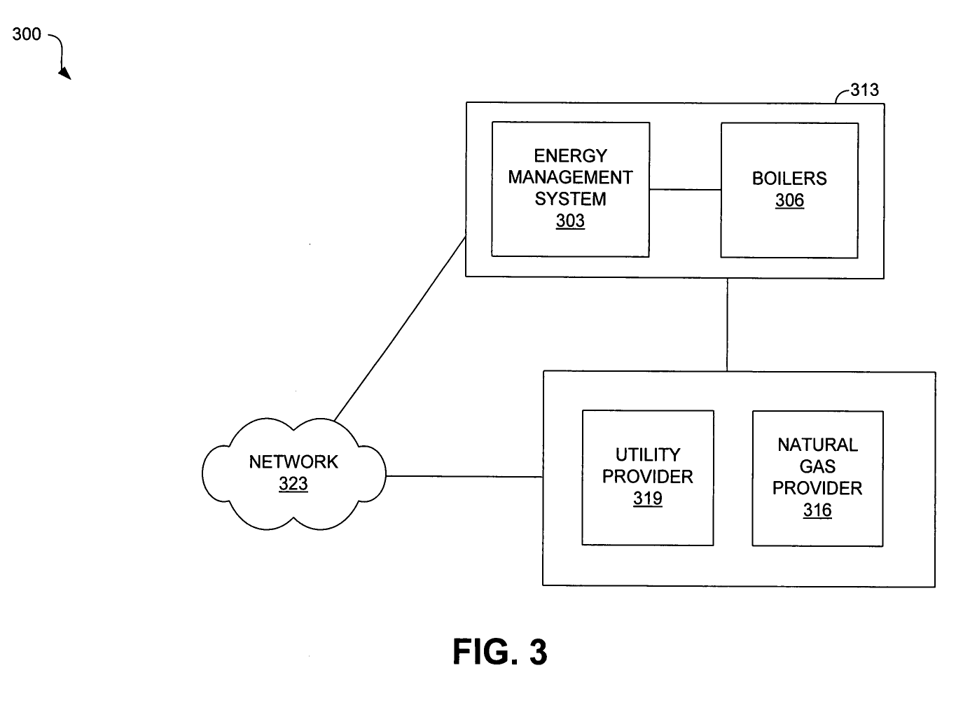

FIG. 3 is a schematic view of another embodiment of a system in which different types of boilers can be operated to maximize cost saving. The system 300 includes a company premises 313 that has an energy management system 303 and different types of boilers 306. The energy management system 303 downloads the schedules of pricing of electricity and natural gas from utility provider 319 and natural gas provider 316, respectively, via a network 323, such as the Internet and PSTN. The energy management system 303 determines and generates an operational schedule based on the schedule pricings and transmits the operational schedule to the different types of boilers 306. The different types of boilers are turned on and operated based on the operational schedule transmitted from the energy management system 303. Operation of the system 300 is described in relation to FIGS. 5-7.

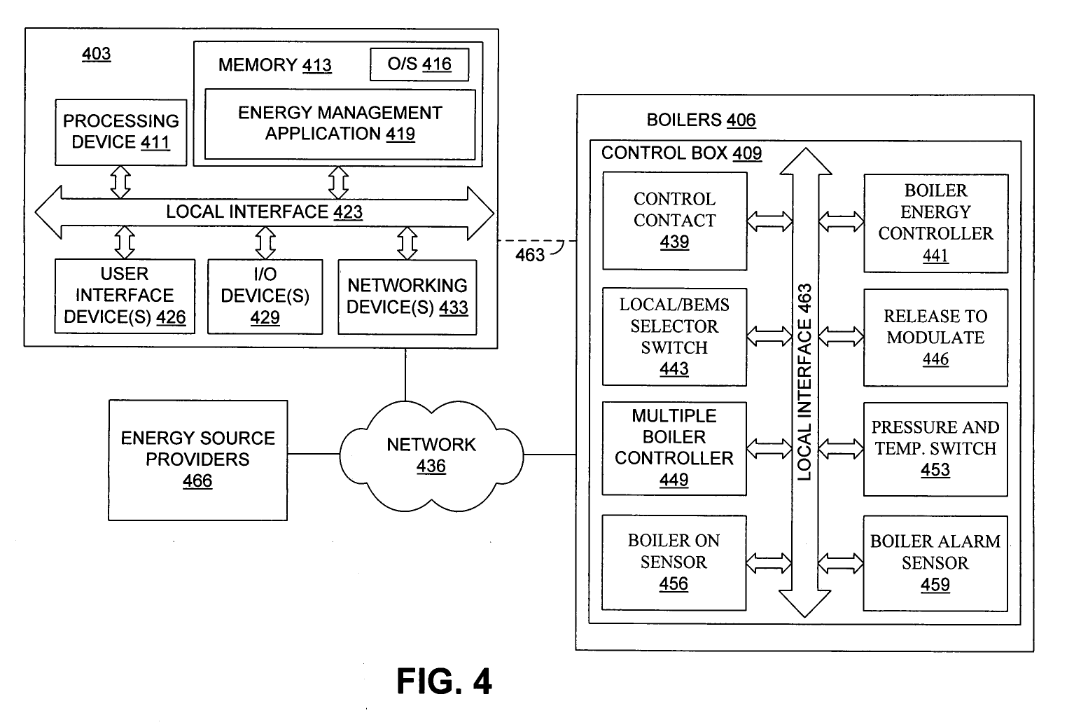

FIG. 4 is a block diagram of an embodiment of an energy management system and boilers. The energy management system 403 comprises processing device 411, memory 413, user interface devices 426, one or more input/output (I/O) devices 429, and one or more networking devices 433, each of which is connected to local interface 423. The processing device 411 can include any custom made or commercially available processor, a central processing unit (CPU) or an auxiliary processor among several processors associated with the energy management system 403, a semi-conductor based microprocessor (in the form of a microchip) or a macro processor. The memory 413 can include any one or a combination of volatile memory elements (e.g., random access memory (RAM), such as DRAM, SRAM, etc.) and non-volatile memory elements (e.g., ROM, hard drive, tape, CD ROM, etc.).

The one or more user interface devices 426 comprise elements with which the user can interact with the energy management system 403. Where the energy management system 403 comprises a personal computer (e.g., desktop or laptop computer) or similar device, these components can comprise those typically used in conjunction with a PC such as a display device, keyboard and mouse.

The one or more I/O devices 429 comprise components used to accelerate connection of the energy management system 403 to other devices and therefore, for instance, comprise one or more serial, parallel, small computer system interface (SCSI), universal serial bus (USB), or IEEE 1394 (e.g., Firewall™) connection elements. The networking devices 433 comprise the various components used to transmit and/or receive data over the network 436, where provided. By way of example, the networking devices 433 include a device that can communicate both inputs and outputs, for instance, a modular/demodular (e.g, modem), a radio frequency (RF), or infrared (IR) transceiver, as well as a network card, etc.

Memory 413 normally comprises various programs (in software and/or firmware), including an operating system (O/S) 416 and an energy management application 419. The OS 416 controls the execution of programs, including the energy management application 419, and provides scheduling, input/output control, file and data management, memory management, communication control and related services. The energy management application 419 facilitates the process for retrieving schedules of prices from energy source providers 466, determines an operational schedule based on the schedules of pricing, and transmits the operational schedule to different types of boilers 406 over the network 436. Alternatively or additionally, the energy management application 419 may transmit the operational schedule to the different types of boilers 406 directly via line 463.

The different types of boilers 406 can be operated through a control box 409. It should be noted that one single control box can manage and operating the different types of boilers 406. Alternatively or additionally, each boiler has a control box for operation and each control box can communicate with each other to accomplish operating the different types of boilers according to the operational schedule. The control box 409 comprises a boiler energy controller 441, control contact 439, local/EMS selector switch 443, release to modulate switch 446, multiple boiler controller 449, pressure and temperature switch 453, boiler on sensor 456, and boiler alarm sensor 459, each of which is connected to local interface 463. The boiler energy controller 441 can be a programmable logic controller or a computing device, such as a desktop or a laptop. The boiler energy controller 441 executes the operational schedule received from the energy management system 403.

The local/EMS selector switch 443 can change the state of the boiler to operate in normal operation where an operator of equipment would turn boiler on/off, or in automatic operation where the on/off function is controlled by the boiler energy controller 441. The control contact 439 turns the boilers on or off, as scheduled by the boiler energy controller 441. The control contact 439 can be a digital contact closure either through a dry set of contacts controlled through the boiler energy controller 441 or controlled by a dry set of contacts activated by a relay which is controlled by the boiler energy controller 441.

The boiler on sensor 456 senses whether the boiler is on and operating and transmits the information to the energy management system 403 via the boiler energy controller 441. This condition/operation is monitored and logged into the energy management system 403. The logged information is used as a confirmation that the boiler is on and operating as scheduled. The logged information can also be used by energy management system 403 to log “run time hours” which can be recorded in a monthly report, which is forwarded to a customer.

The boiler alarm sensor 459 senses when an alarm occurs on the boilers (fault) and transmits the boiler alarm status to the boiler energy controller 441. The boiler energy controller 441 makes corrections automatically by turning on a stand by boiler and notifying the energy management system 403. This alarm can be logged into the energy management system 403 and the appropriate personnel at the facility can be notified. The pressure and temperature switch 453 monitors whether the boiler has satisfied the requirement of minimum steam/boiler temperature/pressure. The pressure and temperature switch 453 closes once the temperature/pressure requirement has been met and notifies the energy management system 403 thereof. The energy management system 403 receives the temperature/pressure notification and sends a release signal to the boiler energy controller 441 to release the boiler to run in automatic 0-100% modulation to maintain steam pressure flow.

Alternatively or additionally, a release to modulate mechanism 446 can be utilized by the energy management system 403. The release to modulate mechanism 446 is controlled by the energy management system 403 and allows the boiler to modulate up to 100% firing rate once the following limits have been satisfied: minimum steam pressure on the boiler drum and minimum steam/water temperature.

Alternatively or additionally, the energy management system 403 can communicate with the multiple boiler controller 449 to allow for boiler plant system steam pressure management. The multiple boiler controller 449 monitors individual boiler steam flow and header pressure. Once the boilers have met their 90% steam flow then the multiple boiler controller 449 determines which boilers to operate and modulate 0-100% accordingly. Alternatively or additionally, the multiple boiler controller 449 may operate independently of the energy management system 403; hence, the multiple boiler controller 449 does not communicate with the energy management system 403. In one embodiment, operation of the system 400 is described in relation to FIGS. 5-7.

FIG. 5 is a flow diagram that illustrates a high-level operation of a system such as shown in FIGS. 1, 2, 3, and 4. The operation 501 retrieves schedules of pricing from energy source providers as indicated in block 503. In block 506, an operational schedule is determined for operating different types of boilers to maximize cost saving based on the retrieved schedules of pricing. In block 509, the different types of boilers are operated according to the operational schedule.

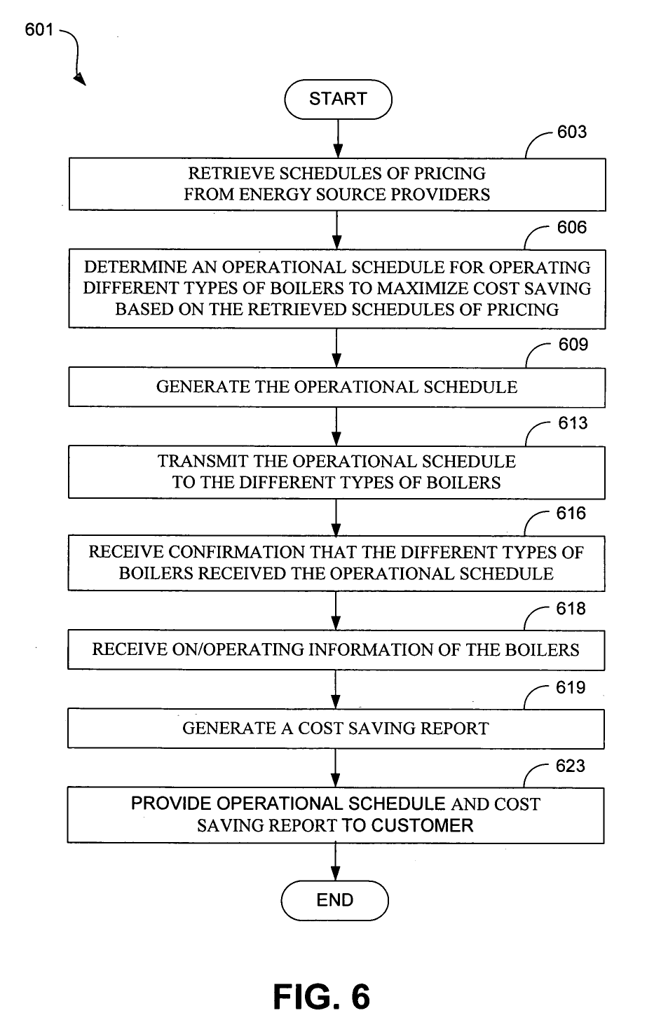

FIG. 6 is a block flow diagram that illustrates operation 601 of an embodiment of an energy management system, such as shown in FIG. 1. The energy management system, in block 603, retrieves schedules of pricing from energy source providers, and in block 606, determines an operational schedule for operating the different types of boilers to maximize cost savings based on the retrieved schedules of pricing. In blocks 609 and 613, the operational schedule is generated and the operational schedule is transmitted to the different types of boilers. In block 616, the energy management system receives confirmation that the different types of boilers have received the operational schedule. In block 618, the energy management system can also receive information whether the different types of boilers are on and operating. This information can determine “run time hours” of the different types of boilers. In block 619, the energy management system generates a cost saving report based on the “run time hours,” and in block 623, provides the operational schedule and the cost saving report to a customer.

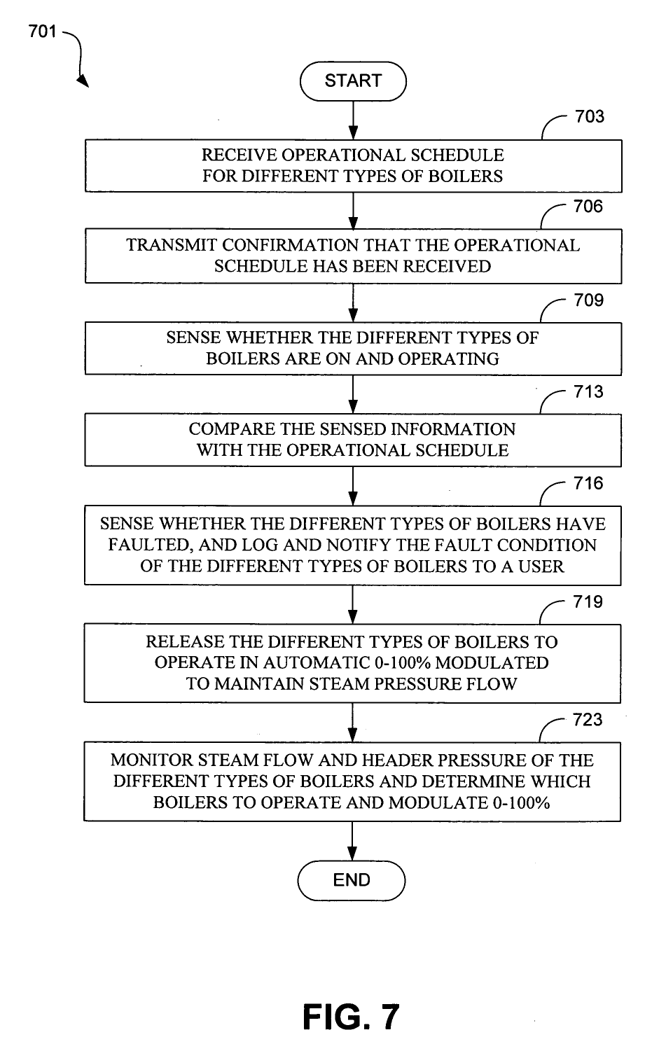

FIG. 7 is a flow diagram that illustrates operation 701 of an embodiment of a boiler control box, such as shown in FIG. 4. The boiler control box, in block 703, receives the operational schedule for different types of boilers, and in block 706, transmits confirmation that the operational schedule has been received. In block 709, the different types of boilers are sensed to determine whether the boilers are on and operating. In block 713, the sense information of whether the boilers are on and operating are compared with the operational schedule to determine whether the different types of boilers are operating according the operational schedule. Alternatively or additionally, the information can be transmitted to an energy management system, which determines “run time hours” of the different types of boilers and generates a cost saving report based on the “run time hours.”

In block 716, the different types of boilers are sensed to determine whether they have faulted. If so, the fault information is transmitted to the energy management system, which notifies the fault condition of the different types of boilers to a user. In block 719, the different types of boiler are released to operate in automatic 0-100% modulation to maintain steam pressure flow. In block 723, steam flow and pressure of the different types of boilers are monitored to determine which boilers to operate and modulate 0-100%.

FIG. 8 is an exemplary operational schedule such as described in relation to FIG. 1. The schedule 801 includes dates 803 of a month and days 806 of a week including hourly segments 809 of the day. For example, on Wednesday of date 1 from 12 a.m.-6 a.m., the controller operates an electric boiler and from 7 a.m.-10 a.m., the controller turns off the electric boiler and turns on and operates a gas boiler. From 11 a.m.-2 p.m., the controller turns off the gas boiler and turns on the electric boiler and from 3 p.m.-7 p.m., the electric boiler is turned off and the gas boiler is turned on. From 8 p.m.-12 a.m., the gas boiler is turned off and the electric boiler is turned on. The schedule 801 also informs the user of run time 813 in which the gas/oil boiler is run at 156 hours and the electric boiler runs for 588 hours for this exemplary month.

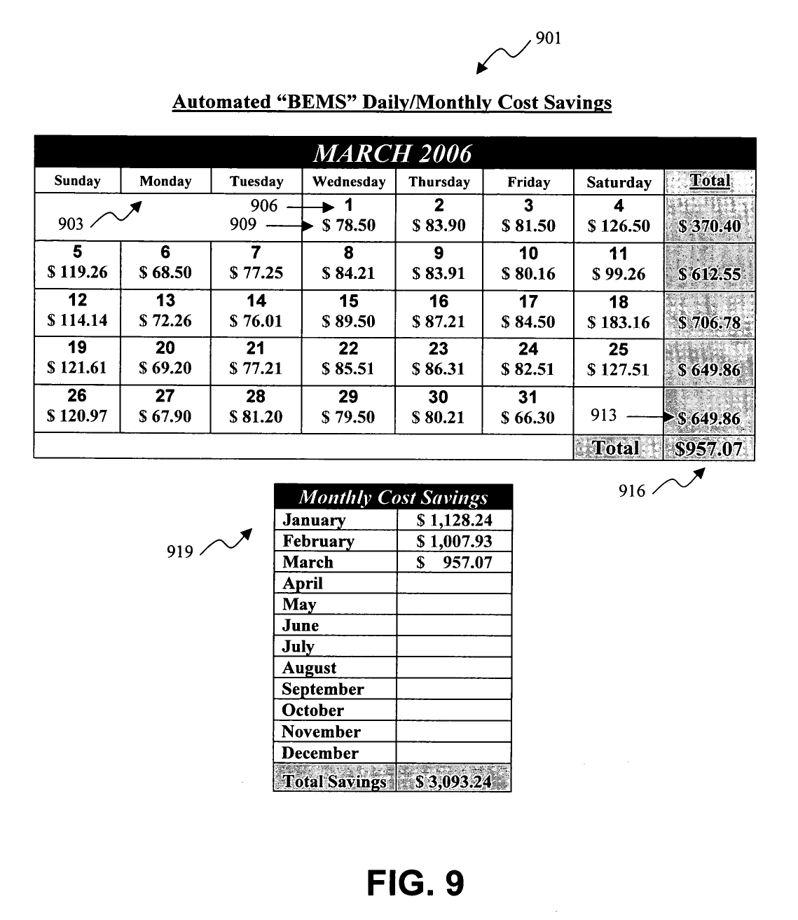

FIG. 9 is an exemplary cost savings report such as described in relation to FIG. 7. The cost saving report 901 illustrates cost savings for a month of operating the boilers. The cost saving report 901 includes days 903 of a week and dates 906 of a month. Each day of the month shows the amount saved 909 for that day. The cost saving report 901 also provides a week cost saving 913 for that particular week, for example, the week from the 26^{th} to the 31^{st} the system saved $496.08 for a customer. For the entire month, the monthly cost savings 916 is $2,835.76. The report also provides previous months' savings 919. In this example, the system saved $1,128.24, $1,007.93 and $2,835.76 in the months of January, February and March, respectively, which is added together to give a total savings 923 of $4,971.84.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

1. A method for managing boilers operation as determined by cost of energy sources comprising:
retrieving schedules of pricing from energy source providers;
determining an operational schedule for operating different types of boilers to maximize cost saving based on the retrieved schedules of pricing, each boiler using a type of energy source during operation;
transmitting the operational schedule to the different types of boilers; and
operating the different types of boilers according to the operational schedule.

2. The method as defined in claim 1, wherein the schedule of pricing is retrieved via Internet,
wherein the operational schedule is transmitted to the different types of boilers via a modem over a public switched telephone network or Internet, and
further comprising storing the operational schedule for historical purpose and generating a cost savings report.

3. The method as defined in claim 1, wherein determining the operational schedule is by way of analyzing and comparing retrieved schedules of pricing from energy source providers based on 24 hour segments of a day, each hour of the segments including instructions to operate one type of boiler of the different types of boilers.

4. The method as defined in claim 1, further comprising operating the different types of boilers in either normal and automatic operations, the normal operation of the different types of boilers enabling a user to turn the boiler on/off, the different types of boilers being operated according to the operational schedule during automatic operation.

5. The method as defined in claim 1, further comprising:
sensing whether the different types of boilers are on and operating;
comparing the sensed information with the operational schedule to determine whether the different types of boilers are operating according to the operational schedule;
sensing whether the different types of boilers have faulted;
logging the fault conditions of the different types of boilers; and
notifying a user of the fault conditions of the different types of boilers.

6. The method as defined in claim 1, further comprising releasing the different types of boilers to operate in automatic 0-100% modulation to maintain steam pressure flow once the different types of boilers satisfies a certain pressure and temperature on a boiler drum of the different types of boilers.

7. The method as defined in claim 1, further comprising monitoring steam flow and header pressure of the different types of boilers and determining which boilers to operate and modulate 0-100% based on the monitored steam flow and header pressure and the operational schedule.

8. A system for managing boilers operation as determined by cost of energy sources comprising:
different types of boilers that are coupled to energy source providers, the energy source providers being operative to providing energy sources to the different types of boilers; and
a boiler energy controller that is coupled to the different types of boilers and facilitates operating the different types of boilers, the boiler energy controller being capable of:
receiving an operational schedule, and
switching the different types of boilers during operation according to the operational schedule.

9. The system as defined in claim 8, wherein the boiler energy controller receives the operational schedule via a modem over a public switched telephone network or Internet.

10. The system as defined in claim 8, wherein the operational schedule is generated by analyzing and comparing schedules of pricing from the energy source providers based on 24 hour segments, each hour of the segments including instructions for the boiler energy controller to operate one type of boiler of the different types of boilers.

11. A system for managing boilers operation as determined by cost of energy sources comprising:
different types of boilers;
energy source providers that provides energy sources to the different types of boilers;
a boiler energy controller that is coupled to the different types of boilers and facilitates operating the different types of boilers; and
an energy management system that communicates with the energy source providers and the boiler energy controller, the energy management system being capable of:
retrieving schedules of pricing from the energy source providers,
determining an operational schedule for operating the different types of boilers to maximize cost saving based on the retrieved schedules of pricing, and
transmitting the operational schedule to the boiler energy controller; and
wherein the boiler energy controller manages operations of the different types of boilers according to the operational schedule.

12. The system as defined in claim 11, wherein the schedule of pricing is retrieved via Internet.

13. The system as defined in claim 11, wherein the operational schedule is transmitted to the boiler energy controller via a modem over a public switched telephone network.

14. The system as defined in claim 11, wherein the operational schedule is generated by analyzing and comparing retrieved schedules of pricing from energy source providers based on 24 hour segments, each hour of the segments including instructions for the boiler energy controller to operate one type of boiler of the different types of boilers according to the operational schedule.

15. The system as defined in claim 11, wherein the different types of boilers further include an on/off selector switch that enables the different types of boilers to operation in both normal and automatic operations, the normal operation of the different types of boilers enabling an operator of equipment to turn the boiler on/off, the automatic operation of the different types of boilers enabling the energy management system to control the different types of boilers.

16. The system as defined in claim 11, wherein the different types of boilers further include a control contact that communicates with the boiler energy controller to turn the boiler on or off according to the operational schedule.

17. The system as defined in claim 11, wherein the different types of boilers further include an on/off sensor that senses whether the different types of boilers are on and operating, information from the on/off sensor being transmitted to the boiler energy controller, the boiler energy controller being operative to monitor and confirm whether different types of boilers are operating according to the operational schedule.

18. The system as defined in claim 11, wherein the different types of boilers further include an alarm sensor that senses whether the different types of boilers has faulted, information from the alarm sensor being transmitted to the boiler energy controller, the boiler energy controller being operative to log and notify the fault condition of the different types of boilers to a user.

19. The system as defined in claim 11, wherein the different types of boilers further includes a pressure and temperature switch that releases the different types of boilers to operate in automatic 0-100% modulation to maintain steam pressure flow once the different types of boilers satisfies a certain pressure and temperature.

20. The system as defined in claim 11, wherein the different types of boilers further includes a multiple boiler controller that monitors steam flow and header pressure of different types of boilers, the multiple boiler controller being operative to determine which boilers to operate and modulate 0-100% based on the monitored steam flow and header pressure and the operational schedule.
